(19) United States
(12) Patent Application Publication
(10) Pub. No.: US 2024/0272942 A1
(43) Pub. Date: Aug. 15, 2024

(54) METHOD, DEVICE, AND STORAGE MEDIUM FOR CONTAINER-BASED PROCESS SCHEDULING

(71) Applicant: TENCENT TECHNOLOGY (SHENZHEN) COMPANY LIMITED, Shenzhen (CN)

(72) Inventor: Zhiguang PENG, Shenzhen (CN)

(21) Appl. No.: 18/630,496

(22) Filed: Apr. 9, 2024

Related U.S. Application Data
(63) Continuation of application No. PCT/CN2023/110686, filed on Aug. 2, 2023.

(30) Foreign Application Priority Data
Sep. 2, 2022 (CN) 202211068759.4

(51) Int. Cl. G06F 9/48

(52) U.S. Cl. CPC G06F 9/4881; G06F 9/4856

(57) ABSTRACT

A container-based process scheduling method includes: obtaining, for a container, running state data of a home central processing unit (CPU) of the container periodically, the home CPU having a binding relationship with the container, a quantity of CPUs bound to the container being less than a target quantity required for meeting a service running requirement of the container; performing service process migration between the home CPU and an away CPU in response to the running state data of the home CPU meeting a load balancing condition, the away CPU not having a binding relationship with the container; determining, in response to a first service process in the container being migrated, a running priority of the first service process on a CPU to which the first service process is migrated; and running the first service process according to the determined running priority.

### CROSS-REFERENCES TO RELATED APPLICATIONS

This application is a continuation application of PCT Patent Application No. PCT/CN2023/110686, filed on Aug. 2, 2023, which claims priority to Chinese Patent Application No. 202211068759.4, filed on Sep. 2, 2022, all of which is incorporated herein by reference in their entirety.

### FIELD OF THE TECHNOLOGY

The present disclosure relates to the field of cloud computing technologies and, in particular, to a container-based process scheduling method and apparatus, a device, and a storage medium.

### BACKGROUND OF THE DISCLOSURE

As Internet technology (IT) and virtualization technology advance, cloud computing has been developed to a new stage. The cloud computing not only changes a service architecture of an enterprise, but also changes an operation mode of the enterprise. Deploying services on a cloud platform is a development trend of future service operation. For example, a container cloud is a container-based cloud platform, and by creating containers on a device, the container cloud can serve a service by providing the containers.

At present, service deployment is generally performed on the container cloud in a hybrid deployment manner. Service processes of a plurality of services are deployed on the same device. Therefore, a plurality of containers are created on the same device for use by different services. For example, service processes of different services are isolated in different containers. Running of a service process depends on central processing unit (CPU) resources. When service process migration is performed, it needs to be considered whether CPU resource utilization is proper and whether the service performance reaches a standard. For example, it is undesirable that some idle CPUs are not able to be used to run a service process in a container cannot appear. This leads to low resource utilization. In another example, it is undesirable that different services have conflicts with each other. For example, a service process of a delay-sensitive service (for example, a game service) and a service process of a non-delay-sensitive service (for example, a machine learning task) may contend for CPU resources, leading to a large scheduling delay of the service process of the delay-sensitive service, and affecting the service performance.

There is a need to provide method, apparatus, device, and storage medium for container-based process scheduling with improved resource utilization and without affecting the service performance.

### SUMMARY

One embodiment of the present disclosure provides a container-based process scheduling method, performed by a computer device. The method includes obtaining, for a container, running state data of a home central processing unit (CPU) of the container periodically, the home CPU being a CPU having a binding relationship with the container on a device, a quantity of CPUs bound to the container being less than a target quantity, and the target quantity being a quantity of CPUs required for meeting a service running requirement of the container; performing service process migration between the home CPU and an away CPU in response to the running state data of the home CPU meeting a load balancing condition, the away CPU being a CPU not having a binding relationship with the container on the device; and determining, in response to a first service process in the container being migrated, a running priority of the first service process on a CPU to which the first service process is migrated; and running the first service process on the CPU to which the first service process is migrated according to the running priority of the first service process.

Another embodiment of the present disclosure provides a computer device. The computer device includes one or more processors and a memory containing a computer program that when being loaded and executed, causes the one or more processors to perform: obtaining, for a container, running state data of a home central processing unit (CPU) of the container periodically, the home CPU being a CPU having a binding relationship with the container on a device, a quantity of CPUs bound to the container being less than a target quantity, and the target quantity being a quantity of CPUs required for meeting a service running requirement of the container; performing service process migration between the home CPU and an away CPU in response to the running state data of the home CPU meeting a load balancing condition, the away CPU being a CPU not having a binding relationship with the container on the device; and determining, in response to a first service process in the container being migrated, a running priority of the first service process on a CPU to which the first service process is migrated; and running the first service process on the CPU to which the first service process is migrated according to the running priority of the first service process.

Another embodiment of the present disclosure provides a non-transitory computer-readable storage medium containing a computer program that, when being loaded and executed, causes one or more processors to perform: obtaining, for a container, running state data of a home central processing unit (CPU) of the container periodically, the home CPU being a CPU having a binding relationship with the container on a device, a quantity of CPUs bound to the container being less than a target quantity, and the target quantity being a quantity of CPUs required for meeting a service running requirement of the container; performing service process migration between the home CPU and an away CPU in response to the running state data of the home CPU meeting a load balancing condition, the away CPU being a CPU not having a binding relationship with the container on the device; and determining, in response to a first service process in the container being migrated, a running priority of the first service process on a CPU to which the first service process is migrated; and running the first service process on the CPU to which the first service process is migrated according to the running priority of the first service process.

### BRIEF DESCRIPTION OF THE DRAWINGS

FIG. 1 is a schematic structural diagram of a computer device according to an exemplary embodiment of the present disclosure.

FIG. 2 is a diagram of a system architecture of a container cloud according to an exemplary embodiment of the present disclosure.

FIG. 3 is a diagram of a system architecture of another container cloud according to an exemplary embodiment of the present disclosure.

FIG. 4 is a schematic diagram of binding between containers and CPUs according to an exemplary embodiment of the present disclosure.

FIG. 5 is a flowchart of a container-based process scheduling method according to an exemplary embodiment of the present disclosure.

FIG. 6 is a schematic diagram of load detection according to an exemplary embodiment of the present disclosure.

FIG. 7 is a schematic diagram of priority controlling according to an exemplary embodiment of the present disclosure.

FIG. 8 is a flowchart of another container-based process scheduling method according to an exemplary embodiment of the present disclosure.

FIG. 9 is a schematic diagram of scaling-up logic according to an exemplary embodiment of the present disclosure.

FIG. 10 is a flowchart of still another container-based process scheduling method according to an exemplary embodiment of the present disclosure.

FIG. 11 is a schematic diagram of scaling-down logic according to an exemplary embodiment of the present disclosure.

FIG. 12 is a schematic diagram of yet another container-based process scheduling method according to an exemplary embodiment of the present disclosure.

FIG. 13 is a schematic structural diagram of a container-based process scheduling apparatus according to an exemplary embodiment of the present disclosure.

### DESCRIPTION OF EMBODIMENTS

To make the objectives, technical solutions, and advantages of present disclosure clearer, the following further describes implementations of present disclosure in detail with reference to the accompanying drawings.

Terms such as “first” and “second” in present disclosure are configured for distinguishing between same items or similar items that have basically same functions and purposes. It is to be understood that “first”, “second”, and “n^{th}” do not have any dependency relationship in logic or in a time sequence, and do not limit a quantity or an execution sequence. It is to be further understood that although the terms such as first and second are used in the following description to describe various elements, the elements are not limited by the terms.

The terms are only configured for distinguishing one element from another element. For example, without departing from the scope of examples, a first element can be referred to as a second element, and similarly, the second element can also be referred to as the first element. The first element and the second element may both be elements, and in some cases, may be independent and different elements.

At least one means one or more than one, and for example, at least one element may be any element whose quantity is an integer greater than or equal to one such as one element, two elements, or three elements. A plurality of means two or more than two, and for example, a plurality of elements may be any elements whose quantity is an integer greater than or equal to two such as two elements or three elements.

Information (including but not limited to user device information and user personal information), data (including but not limited to data configured for analysis, stored data, and presented data), and signals involved in present disclosure are all authorized by a user or fully authorized by each party, and sample collection, usage, and processing of related data need to comply with related laws, regulations, and standards of related countries and regions.

A container-based process scheduling solution provided in embodiments of present disclosure relates to a cloud technology. The cloud technology is a hosting technology that unifies a series of resources such as hardware, software, and networks in a wide area network or a local area network to implement computing, storage, processing, and sharing of data.

The cloud technology is a collective name of a network technology, an information technology, an integration technology, a management platform technology, an application technology, and the like based on an application of a cloud computing business mode, and may form a resource pool, which is used as required, and is flexible and convenient. The cloud computing technology becomes an important support. A background service of a technical network system requires a large amount of computing and storage resources, such as video websites, image websites, and more portal websites. As the Internet industry is highly developed and applied, each article may have its own identifier in the future and needs to be transmitted to a background system for logical processing. Data at different levels is separately processed, and data in various industries requires a strong system support, which can only be implemented through cloud computing.

The cloud computing refers to a payment and use mode of IT infrastructure and is to obtain required resources through a network as required and in an easy expansion manner. In a broad sense, the cloud computing refers to a payment and use mode of a service and is to obtain a required service through a network as required and in an easy expansion manner. This service may be correlating IT with software or the Internet, or may be another service. The cloud computing is a product of development and fusion of conventional computer and network technologies such as grid computing, distributed computing, parallel computing, utility computing, network storage technologies, virtualization, and load balancing.

With the development of the Internet, real-time data stream, and connection device diversity, and through the promotion of requirements for a search service, a social network, mobile business, and open collaboration, the cloud computing is rapidly developed. Different from the previous parallel or distributed computing, generation of the cloud computing may ideally bring revolutionary revolution to the entire Internet mode and an enterprise management mode.

The following first describes some key terms or abbreviations involved in the embodiments of present disclosure.

Container: In Linux, a container technology is a process isolation technology. In a computing form, the container technology is a virtualization technology at an operating system layer with a lightweight kernel. The container can isolate a process in an independent environment.

Container cloud: This is a product form emerging in the cloud computing technology, and the container cloud is a container management platform formed by containers, which provides great convenience to a user when using the containers. By creating containers on a physical machine or a virtual machine, the container cloud can serve a service by providing the containers. In other words, the container cloud uses a container as a basic unit of resource allocation and scheduling, encapsulates a software running environment, and provides a platform configured for constructing, publishing, and running a distributed application to a developer and a system administrator.

Hybrid deployment: This refers to deploying processes of a plurality of services on the same device. In some embodiments, the services mentioned herein include, but not limited to, a game service, a search service, an information flow service, an electronic business transaction service, a big data service, a machine learning service, and a storage service.

Process scheduling: Generally speaking, by using one CPU as an example, process scheduling is to dynamically allocate the CPU to one process in a run queue according to a specific rule to execute the process. In other words, process scheduling is to select one process from a run queue according to a specific rule, to cause the process to obtain a CPU.

In the embodiments of present disclosure, process scheduling refers to scheduling a process between different CPUs to execute the process.

cpuset mechanism: In Linux, the basic function of the cpuset is to limit some processes to being run only on some CPUs of a device. For example, assuming that there are four processes and four CPUs on a device, the cpuset can make the first process and the second process be run only on the first CPU and the second CPU. In other words, the cpuset is configured for limiting a range of CPUs on which a process can be run.

Overcommitting: In the embodiments of present disclosure, overcommitting refers to deploying more containers on a device with a fixed specification.

In some embodiments, the fixed specification refers to a fixed quantity of CPUs. In this case, overcommitting means that a quantity of CPUs required by containers that are actually deployed is greater than a quantity of CPUs on the device. For example, to ensure the service serving quality of each container, each container requires four CPUs, and only eight CPUs are deployed on the device, but two or more containers are deployed to use the eight CPUs, to improve the resource utilization.

The following describes implementation environments related to the container-based process scheduling solution provided in the embodiments of present disclosure.

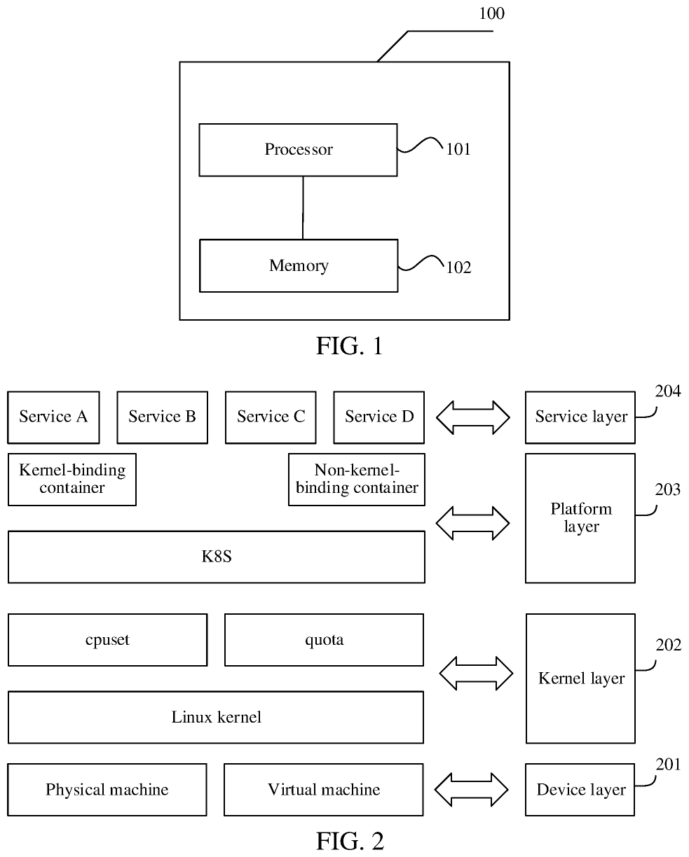

In some embodiments, at a device level, a container-based process scheduling method provided in the embodiments of present disclosure is applied to a computer device shown in FIG. 1 or a virtual machine created on the computer device. That is, the container-based process scheduling method provided in the embodiments of present disclosure may be performed by the computer device shown in FIG. 1 or may be performed by the virtual machine created on the computer device. The computer device is also referred to as a physical machine or a physical server in the embodiments of present disclosure.

FIG. 1 is a schematic structural diagram of a computer device shown according to an exemplary embodiment.

Referring to FIG. 1, the computer device 100 may vary greatly due to different configurations or performance, and may include one or more central processing units (also referred to as processors) 101 and one or more memories 102. The memory 102 stores at least one piece of program code, and the at least one piece of program code is loaded and executed by the central processing unit 101 to implement the container-based process scheduling method provided in the embodiments of present disclosure. The at least one piece of program code may be referred to as a computer program. Certainly, the computer device 100 may also have components such as a wired or wireless network interface, a keyboard, and an input/output interface for ease of input/output, and the computer device 100 may further include other components for implementing functions of the device. Details are not described herein again.

In some other embodiments, at a system architecture level, the container-based process scheduling method provided in the embodiments of present disclosure is applied to a kernel layer in a system architecture of a container cloud shown in FIG. 2.

FIG. 2 is a diagram of a system architecture of a container cloud shown according to an exemplary embodiment.

Referring to FIG. 2, the system architecture sequentially includes a device layer 201, a kernel layer 202, a platform layer 203, and a service layer 204 from bottom to top. The device layer 201 includes a physical machine and a virtual machine. The kernel layer 202 is configured to provide a resource management function and a process scheduling function. For example, the kernel layer 202 further provides a cpuset mechanism and a quota mechanism. A container kubernetes (k8s) of the platform layer 203 uses the cpuset mechanism and the quota mechanism provided by the kernel layer 202, to generate a kernel-binding container or a non-kernel-binding container and provide the container for use by different services at the service layer 204. The service layer 204 includes various services that are deployed in a hybrid manner. FIG. 2 only shows four services: a service A, a service B, a service C, and a service D, and actually, the service layer 204 may include more or fewer services, which is not limited in present disclosure.

The cpuset mechanism may limit that a service process in a container can be only run on a fixed CPU of a device, that is, limit a range of CPU resources that can be used by the service process. In other words, the cpuset mechanism allocates CPU resources to use by the service process in the container in a CPU binding manner. Correspondingly, kernel binding mentioned above is an affinity between a set process and a kernel of a CPU. After setting is completed, the process is only run on the bound CPU. In the quota mechanism, binding between containers and CPUs is not performed, a service process in a container can be run on any CPU, but CPU resources that may be used by each container in a fixed time period is limited based on the quota mechanism.

For example, assuming that eight CPUs are deployed on a device and each container requires four CPUs, the four CPUs are a quantity of CPUs required for meeting a service running requirement of the container, that is, an amount of CPU resources required for ensuring the service serving quality of the container. For the cpuset mechanism, to avoid conflicts between different services, each container is independently bound to four CPUs, so that the eight CPUs may be allocated to two containers. In a non-kernel-binding case, through the quota mechanism, a CPU resource quota used by each container in the fixed time period may be limited to 400%. The fixed time period generally is 100 ms (milliseconds), and 400% indicates that at most 400 ms of CPU time is used within every time period lasting for 100 ms, namely, at most 4 CPUs are used. That is, a service process in a container may be run on any four of the eight CPUs. In this case, CPU overcommitting to some extent may be implemented. For example, although there are only eight CPUs on the device, the eight CPUs may be allocated to three or more containers.

In conclusion, for the cpuset mechanism, although different services do not conflict with each other, the CPU overcommit ratio is low, and even if some CPUs are in an idle state, these CPUs cannot be used to run a service process in a non-bound container, leading to low resource utilization; and for the quota mechanism, overcommitting to some extent can be implemented, but because containers and CPUs are not bound, services conflict with each other. For example, a service process of a delay-sensitive service and a service process of a non-delay-sensitive service may contend for CPU resources, leading to a relatively large running delay of the service process of the delay-sensitive service, and affecting the service performance.

When different services are deployed on the same device, to consider both the resource utilization and the service performance, an embodiment of present disclosure provides a container-based process scheduling solution, which can deploy more containers on the same device for use by different services, and each container can be bound to fewer CPUs, so that higher CPU overcommitting is implemented without affecting the service performance, thereby significantly improving the resource utilization.

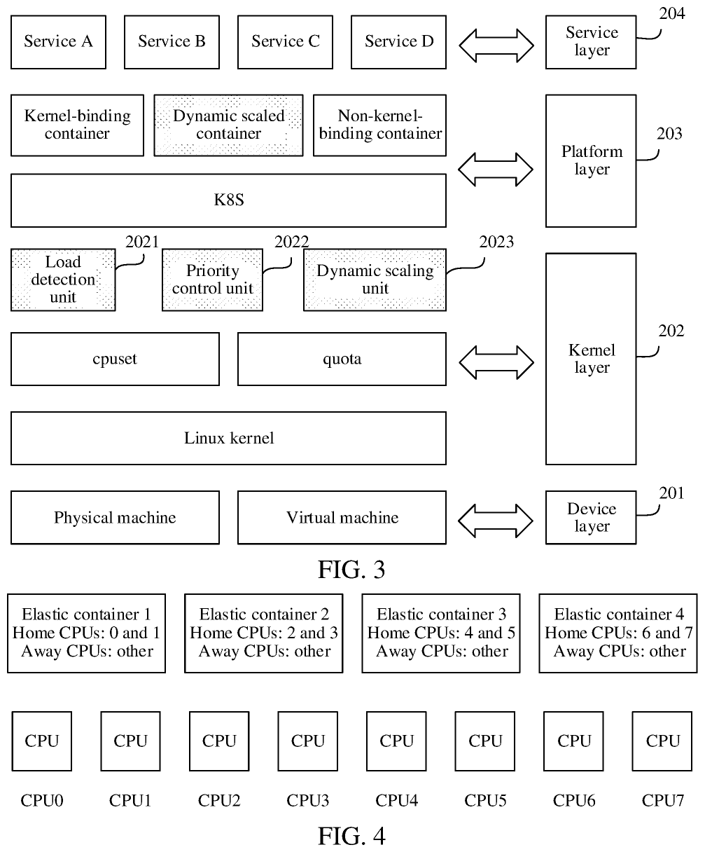

FIG. 3 is a diagram of a system architecture of another container cloud shown according to an exemplary embodiment.

Referring to FIG. 3, three units are newly added above the kernel layer 202, which are respectively a load detection unit 2021, a priority control unit 2022, and a dynamic scaling unit 2023. Correspondingly, at the platform layer 203, in addition to the kernel-binding container and the non-kernel-binding container, a container type, that is, a dynamic scaled container (also referred to as an elastic container) is further added.

For case of understanding the dynamic scaling mentioned above, the following first describes kernel binding logic of the embodiments of present disclosure. When a plurality of services are deployed in a hybrid manner on the same device, for any container on the device, a binding relationship between the container and some CPUs on the device may be established, to further form home CPUs of the container. A quantity of CPUs bound to the container is less than a target quantity, and the target quantity is a quantity of CPUs required for meeting a service running requirement of each container. That is, in the embodiments of present disclosure, fewer CPUs may be bound to each container. A CPU not having a binding relationship with the container is referred to as an away CPU of the container in the embodiments of present disclosure. For example, as shown in FIG. 4, assuming that eight CPUs are deployed on the device, which are respectively a CPU0 to a CPU7, each container requires four CPUs, but only two CPUs are bound to each container in the embodiments of present disclosure. Using the container 1 as an example, the container 1 only has a binding relationship with the CPU0 and the CPU1, and the CPU2 to the CPU7 are away CPUs of the container 1. In addition, a service process in the container 1 is referred to as a home process of the CPU0 and the CPU1 in the embodiments of present disclosure, and a service process in the container 2 to the container 4 are referred to as an away process of the CPU0 and the CPU1 in the embodiments of present disclosure.

In conclusion, the load detection unit 2021 is configured to obtain running state data of each CPU on the device. An example in which the running state data includes a load and a scheduling delay of each process in a run queue is used, the load detection unit 2021 is configured to detect a load change situation and the scheduling delay of each process in the run queue of each CPU on the device. By obtaining the load change situation and the scheduling delay of each process in the run queue of each CPU, the data may assist in determining whether a service process in each container can be only run on a home CPU or may be expanded to an away CPU for running.

Process scheduling is a very important aspect, namely, control logic of a running priority. To achieve a higher overcommit ratio, the embodiments of present disclosure propose the concepts of the home CPU and the away CPU. Because an away CPU of a container A may correspond to a home CPU of a container B, when a service process in the container A needs to be expanded to an away CPU for running, it needs to be further determined that running of a home process on the away CPU is not affected. Based on this, an embodiment of present disclosure provides priority control logic. In some embodiments, the priority control unit 2022 is configured to determine a running priority of a migrated service process on a CPU to which the service process is migrated, where running priorities of a service process on a home CPU and an away CPU are different, and for example, a running priority of the service process on the home CPU is higher than a running priority of the service process on the away CPU.

In some other embodiments, scaling includes scaling-up and scaling-down. The scaling-up refers to that a service process in a container is expanded from a home CPU of the container to an away CPU of the container for running. The scaling-down refers to that a migrated service process is migrated back to a home CPU for running. That is, a range of CPUs on which a service process in a container can be run can be changed and is not limited to a bound home CPU. Therefore, in the embodiments of present disclosure, a container is also referred to as an elastic container or a dynamic scaled container. In addition, scaling-up and scaling-down can be dynamically performed according to a detection result of the load detection unit, so that the scaling-up and scaling-down are referred to as dynamic scaling. Correspondingly, the dynamic scaling unit 2023 is configured to control, according to the detection result of the load detection unit 2021, a service process in each container to be run on a home CPU or expanded to an away CPU for running; or control a service process whether to be migrated from an away CPU of a container to which the service process belongs to back to a home CPU of the container to which the service process belongs for running.

The following describes application scenarios of the container-based process scheduling solution provided in the embodiments of present disclosure.

In some embodiments, the container-based process scheduling solution provided in the embodiments of present disclosure can also be applied to, in addition to a container cloud scenario, an online and online hybrid deployment scenario, an offline and online hybrid deployment scenario, and a cost optimization scenario. For example, the online and online hybrid deployment scenario, the offline and online hybrid deployment scenario, and the cost optimization scenario may relate to a container cloud technology, which is not limited in present disclosure.

Online refers to an online service, and offline refers to an offline service. The online service generally has long running time with significantly fluctuated resource utilization and is sensitive to a delay, for example, an information flow service or an electronic business transaction service. The offline service generally has relatively high resource utilization during running but is generally not sensitive to a delay, for example, a machine learning service.

For the offline and online hybrid deployment scenario, meanings of the hybrid deployment are to mix an online service and an offline service onto the same physical resources, to fully utilize the resources through control means such as resource isolation and scheduling and ensure the serving stability. In other words, because the resource utilization of the online service is significantly fluctuated, a main scenario of the hybrid deployment is to fill the offline service to utilize idle resources in each time period of the online service to reduce cost expense. Correspondingly, for the online and online hybrid deployment scenario, meanings of the hybrid deployment are to mix different online services onto the same physical resources.

For the container cloud scenario, the scheduling solution provided in the embodiments of present disclosure can achieve higher resource overcommitting while ensuring the service performance. In addition, a credible solution is additionally provided for a resource allocation manner of each container in the container cloud scenario.

For the online and online hybrid deployment scenario, the scheduling solution provided in the embodiments of present disclosure fixedly allocates fewer resources (for example, fewer CPUs are bound) for each container, so that more online services may be deployed in a hybrid manner on a machine with the same performance.

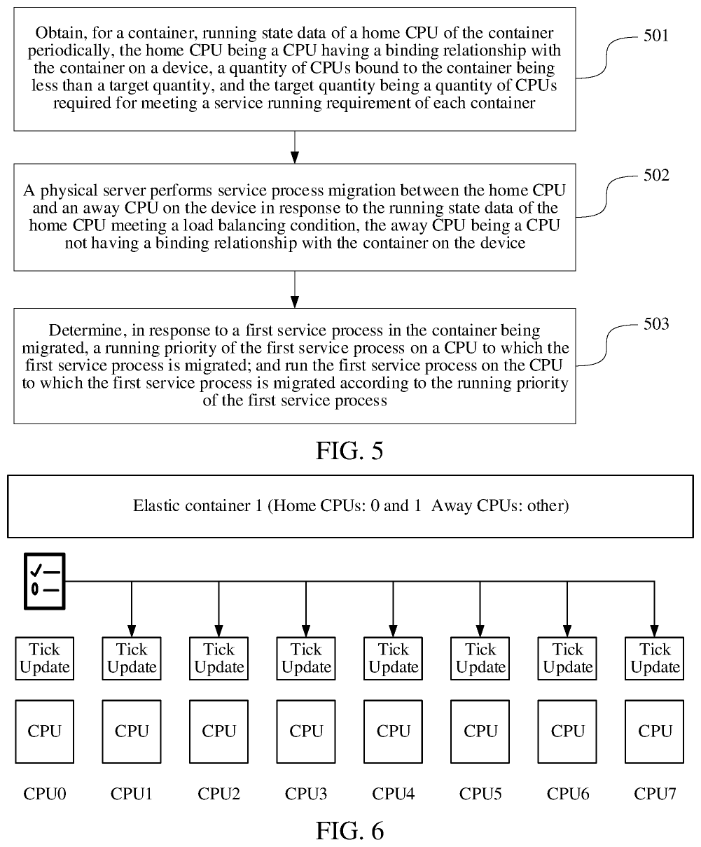

FIG. 5 is a flowchart of a container-based process scheduling method shown according to an exemplary embodiment. As described above, at the device level, the method is executed by a computer device or a virtual machine created on the computer device, where the computer device is also referred to as a physical machine or a physical server. At the system architecture level, the method is executed by a kernel layer in a system architecture of a container cloud. Using the physical server as an example, referring to FIG. 5, a procedure of the method includes the following steps.

501. For any container, the physical server obtains running state data of a home CPU of the container periodically. The home CPU is a CPU having a binding relationship with the container on a device, a quantity of CPUs bound to the container is less than a target quantity, and the target quantity is a quantity of CPUs required for meeting a service running requirement of each container.

This step is performed by a load detection unit provided by a kernel of a CPU deployed on the physical server. The home CPU mentioned in step 501 to step 503 refers to any home CPU bound to the container. In the embodiments of present disclosure, the load detection unit may obtain the running state data of each CPU on the device periodically, and description is provided herein by only using any home CPU of any container as an example.

The running state data of a CPU is configured for reflecting the running busyness of the CPU. In some embodiments, the running state data includes at least one of a load and a scheduling delay of each process in a run queue of the CPU. By using any home CPU of any container as an example, the obtaining running state data of a home CPU of the container periodically includes at least one of the following:
obtaining a load of the home CPU periodically; and
obtaining a scheduling delay of each process in a run queue of the home CPU periodically.

The scheduling delay is also referred to as a scheduling latency, and is essentially a time interval for ensuring that each runnable process can be run at least once. In other words, the scheduling delay is a period of time from a time point that a process meets a condition of being run (enters the run queue of the CPU) to a time point that the process is actually run (obtains execution right of the CPU).

An example in which the running state data includes the load is used, as shown in FIG. 6, in the embodiments of present disclosure, a load situation may be updated by using a periodical tick on each CPU, and whether a service process is run on the home CPU or expanded to an away CPU for running is determined according to an updated load situation. FIG. 6 shows a case that a service process in a container 1 may need to be expanded from an original CPU0 to another CPU for running according to an updated load situation. In FIG. 6, another home CPU (that is, CPU1) may also serve as an object for expansion and running, and actually, only away CPU2 to away CPU7 may alternatively serve as objects for expansion and running, which is not limited in present disclosure

The tick is a relative time unit of an operating system and is also referred to as a time base of an operating system, and comes from a periodical interrupt (output pulse) of a timer, where one interrupt indicates one tick, which is also referred to as one “clock tick”. A correspondence between one tick and time may be set when the timer is initialized, that is, a time length corresponding to the tick may be adjusted. Generally, the kernel provides a corresponding adjustment mechanism, so that the time length corresponding to the tick may be changed according to a specific situation. For example, the operating system may generate one tick every 5 ms, or the operating system may generate one tick every 10 ms. The time granularity of the operating system is determined by the size of the tick.

To sense a load change of each CPU keenly and consider a short-term fluctuation of the load, load counting is not performed in each tick, but may be performed at an interval of several ticks. In some possible implementation, a load situation of each CPU is counted by using a calculation formula only when the time reaches a scheduling period. The scheduling period refers to a time period for running all runnable processes on a CPU once. For example, the scheduling period is 24 ms, which is not limited in present disclosure.

Based on the foregoing description, in the embodiments of present disclosure, the obtaining a load of the home CPU periodically includes but is not limited to the following manners:
obtaining an average load of the home CPU in a fixed time length in a current scheduling period, where the average load is configured for indicating an average quantity of processes in the run queue of the home CPU; obtaining an average load of the home CPU in a previous scheduling period; and obtaining an average load of the home CPU in the current scheduling period according to the average load of the home CPU in the fixed time length and the average load of the home CPU in the previous scheduling period.

The average load in the fixed time length rq.load_{avg} is obtained by the kernel through statistical calculation, where rq refers to a run queue. For example, the fixed time length is 1 minute, 5 minutes, or 15 minutes, which is not limited in present disclosure.

In some other embodiments, in the embodiments of present disclosure, the average load of the home CPU in the current scheduling period is obtained based on the following calculation formula.

$${load}_{avg} = α * ( d - rq . {load}_{avg} ) + β * rq . {load}_{avg}$$

For example, d represents the average load of the home CPU in the previous scheduling period, rq.load_{avg} represents the average load of the home CPU in the fixed time length, α=0.8, β=0.2, and load_{avg} represents the average load of the home CPU in the current scheduling period.

In the embodiments of present disclosure, a load of each CPU in any scheduling period may be calculated through the foregoing calculation formula.

The foregoing describes how to calculate the load situation of each CPU periodically, and the following describes how to store the load situation of each CPU. In some embodiments, in a running process of each service process, it may be determined whether to update load situation of a corresponding home CPU and a corresponding away CPU; and if a time length to a time point at which updating is performed last time is greater than a specific time length (a time interval of one updating period), reading of loads of the corresponding home CPU and the corresponding away CPU may be triggered and the loads are stored. For example, the updating period is consistent with the scheduling period and is also 24 ms, which is not limited in present disclosure.

In some other embodiments, the obtaining running state data of a home CPU having a binding relationship with the container periodically includes but is not limited to the following manners:
obtaining a scheduling delay of each home process in a home process list of the home CPU periodically, where the home process is a service process in the container; and
obtaining a scheduling delay of each away process in an away process list of the home CPU periodically, where the away process is a service process in a container not having a binding relationship with the home CPU.

In other words, each CPU includes a home process list and an away process list, and for the home process list and the away process list, scheduling delay counting may be performed periodically in the embodiments of present disclosure. For example, a time interval for performing counting periodically may be consistent with the scheduling period or may be consistent with the tick, which is not limited in present disclosure. Through the foregoing manner, a scheduling delay change of each process can be sensed keenly.

In some other embodiments, a quantity of CPUs that may be bound to each container and a quantity of CPUs that may be expanded may be adjusted dynamically, and different values may be assigned according to an actual situation, which are not limited in present disclosure. For example, a ratio of expansion (a quantity of expanded CPUs) to reduction (a quantity of bound CPUs) may be controlled through a control parameter sysctl, which is not limited in present disclosure.

502. The physical server performs service process migration between the home CPU and an away CPU on the device in response to that the running state data of the home CPU meets a load balancing condition, where the away CPU is a CPU not having a binding relationship with the container on the device.

This step is performed by a dynamic scaling unit provided by the kernel of the CPU deployed on the physical server.

The service process migration includes scaling-up logic and scaling-down logic. That is, for any container, in response to that running state data of a home CPU and an away CPU of the container meets the load balancing condition, scaling-up and scaling-down may be triggered. In this case, a service process needs to be expanded to the away CPU for running or migrated back to the home CPU for running. For example, the scaling-up logic and the scaling-down logic based on load balancing include but are not limited to the following cases.

Case one. The scaling-up logic is that, the running state data of the home CPU of the container meets the load balancing condition, for example, a load is increased or a scheduling delay of a service process is excessively large, and some service processes need to be expanded to the away CPU for running may occur.

Case two. When the service process is run on the away CPU, scaling-down in two cases may occur. One case is that the running state data of the away CPU meets the load balancing condition, for example, a load is increased or a scheduling delay of the service process migrated to the away CPU is excessively large; and another case is that the load on the home CPU has been low for a period of time, in this case, the service process also needs to be migrated back to the home CPU for running.

For more detailed description of the scaling-up logic and the scaling-down logic, reference may be made to the following embodiments.

503. The physical server determines, in response to migration of a first service process in the container, a running priority of the first service process on a CPU to which the first service process is migrated; and runs the first service process on the CPU to which the first service process is migrated according to the running priority of the first service process.

This step is performed by a priority control unit provided by the kernel of the CPU deployed on the physical server.

In some embodiments, a running priority of a service process on a corresponding home CPU is higher than a running priority thereof on a corresponding away CPU. Correspondingly, the determining a running priority of the first service process on a CPU to which the first service process is migrated includes but is not limited to the following manners: setting, in response to that the CPU to which the first service process is migrated is the home CPU, the running priority of the first service process on the CPU to which the first service process is migrated to a first running priority; and setting, in response to that the CPU to which the first service process is migrated is an away CPU not having a binding relationship with the container, the running priority of the first service process on the CPU to which the first service process is migrated to a second running priority, where the first running priority is higher than the second running priority.

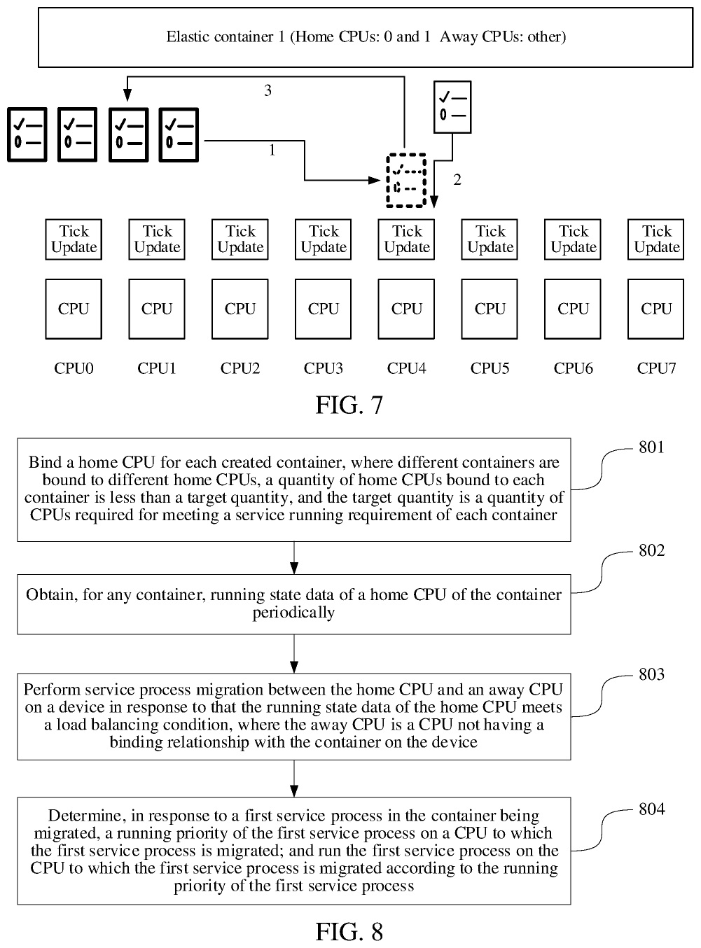

For example, FIG. 7 shows a running priority control situation of a service process in a container 1 expanded from a home CPU (CPU0 and CPU1) to an away CPU (for example, CPU4) for running. Referring to FIG. 7, eight CPUs are deployed on a device in total, where home CPUs of the container 1 are a CPU0 and a CPU1, and away CPUs are a CPU2 to a CPU7. When a service process in the container 1 is run on the CPU0 and the CPU1, a running priority of the service process is set to a high running priority. Assuming that running state data of the CPU1 meets a load balancing condition, a scaling-up condition is met, and the service process in the container 1 may be expanded to another CPU for running, that is, join in a run queue of the another CPU. FIG. 7 shows that a service process in the container 1 is expanded to the CPU4 for running (step 1 in FIG. 7), and in this case, the running priority of the service process is set to a low running priority on the CPU4; when a home process on the CPU4 is woken up and needs CPU resources, the home process may obtain the CPU resources with a high running priority (step 2 in FIG. 7); and when a load on the CPU4 is increased or a scheduling delay of a service process with a low running priority is excessively large, a scaling-down condition is met, the service process that is migrated before may be migrated back to the CPU1 (step 3 in FIG. 7), and in this case, the running priority of the service process is set back to a high running priority.

In conclusion, a running priority setting policy may be that: when a service process enters a queue, determining whether a CPU whose queue is entered by the service process is a corresponding home CPU of the service process; and if yes, setting a running priority of the service process to a high running priority; or when a service process enters a queue, determining whether a CPU whose queue is entered by the service process is a corresponding away CPU of the service process; and if yes, setting a running priority of the service process to a low running priority. Through the foregoing manner, it is ensured that a running priority of any service process in a container on a home CPU is higher than a running priority thereof on an away CPU, so that it is ensured that the service performance of a service on a CPU to which the service process is migrated is not affected by the migrated service process, thereby considering the service performance and the resource utilization.

When the scheduling solution provided in the embodiments of present disclosure is applied to a scenario that different services are deployed on the same device, the scheduling solution first provides concepts of a home CPU and an away CPU based on a binding relationship between a container on a device and CPUs; and for any container, a CPU having a binding relationship with the container is referred to as a home CPU of the container, and a CPU not having a binding relationship with the container is referred to as an away CPU of the container. In addition, a quantity of CPUs bound to each container is less than a target quantity, where the target quantity is a quantity of CPUs required for meeting a service running requirement of each container. Each container is bound to a small quantity of CPUs, so that more containers can be deployed on the same device for use by different services, relatively high CPU resource overcommitting is implemented, and the resource utilization can be improved. The overcommitting herein refers to that actually owned CPU resources are less than allocated CPU resources.

In addition, the embodiments of present disclosure further support service process scheduling between a plurality of CPUs, which can implement service process migration efficiently. In detail, for any home CPU of the container, in response to that running state data of the home CPU meets a load balancing condition, service process migration is performed between the home CPU and an away CPU of the container. This scheduling manner can avoid occurrence of a case that even if some CPUs are in an idle state, these CPUs cannot be used to run a service process, thereby ensuring the resource utilization.

In addition, the embodiments of present disclosure further provides a concept of a running priority; and assuming that a first service process in the container is migrated, a running priority of the first service process on a CPU to which the first service process is migrated is determined, and the first service process is further run on the CPU to which the first service process is migrated according to the running priority of the first service process. This priority-based control manner can avoid occurrence of a case that different services conflict with each other. Running of the first service process on the CPU to which the first service process is migrated according to the determined priority does not affect running of each service process in each container bound to the CPU on the CPU, thereby ensuring the service performance.

In conclusion, the scheduling solution provided in the embodiments of present disclosure can consider the service performance and the resource utilization. For example, for a container cloud scenario, the embodiments of present disclosure provide a new manner for allocating CPU resources for each container, thereby considering the container performance and a CPU overcommit ratio. In addition, a service process has different priorities when run on a home CPU and an away CPU, thereby ensuring the service performance.

FIG. 8 is a flowchart of another container-based process scheduling method shown according to an exemplary embodiment. As described above, at the device level, the method is executed by a computer device or a virtual machine created on the computer device, where the computer device is also referred to as a physical machine or a physical server. At the system architecture level, the method is executed by a kernel layer in a system architecture of a container cloud. Using the physical server as an example, referring to FIG. 8, a procedure of the method includes the following steps.

801. The physical server binds a home CPU for each created container, where different containers are bound to different home CPUs, a quantity of home CPUs bound to each container is less than a target quantity, and the target quantity is a quantity of CPUs required for meeting a service running requirement of each container.

Different containers are bound to different home CPUs, that is, each container is bound to a different CPU on a device. As shown in FIG. 4, CPUs bound to the container 1 are a CPU0 and a CPU1, that is, home CPUs of the container 1 are the CPU0 and the CPU1; CPUs bound to the container 2 are a CPU2 and a CPU3, that is, home CPUs of the container 2 are the CPU2 and the CPU3; CPUs bound to the container 3 are a CPU4 and a CPU5, that is, home CPUs of the container 3 are the CPU4 and the CPU5; and CPUs bound to the container 4 are a CPU6 and a CPU7, that is, home CPUs of the container 4 are the CPU6 and the CPU7.

802. The physical server obtains, for any container, running state data of a home CPU of the container periodically.

In the embodiments of present disclosure, the load detection unit may obtain the running state data of each CPU on the device periodically, and description is provided herein by only using any home CPU of any container as an example.

In some embodiments, the running state data includes at least one of a load and a scheduling delay of each process in a run queue of the CPU. An example in which the running state data includes the load is used, service process scheduling is not performed in response to that a load of the home CPU does not meet a load balancing condition. For example, that the load balancing condition is not met herein may refer to that the load of the home CPU is lower than a load threshold. For example, a value of the load threshold is 0.6, which is not limited in present disclosure.

803. The physical server performs service process migration between the home CPU and an away CPU on the device in response to that the running state data of the home CPU meets a load balancing condition, where the away CPU is a CPU not having a binding relationship with the container on the device.

A first service process, a second service process, a third service process, a fourth service process, a first CPU, a second CPU, a third CPU, a fourth CPU, a first load threshold, a second load threshold, a third load threshold, a first time threshold, and a second time threshold appearing in the following content are only provided for distinguishing between different service processes, CPUs, load thresholds, and time thresholds, and do not constitute any other limitation.

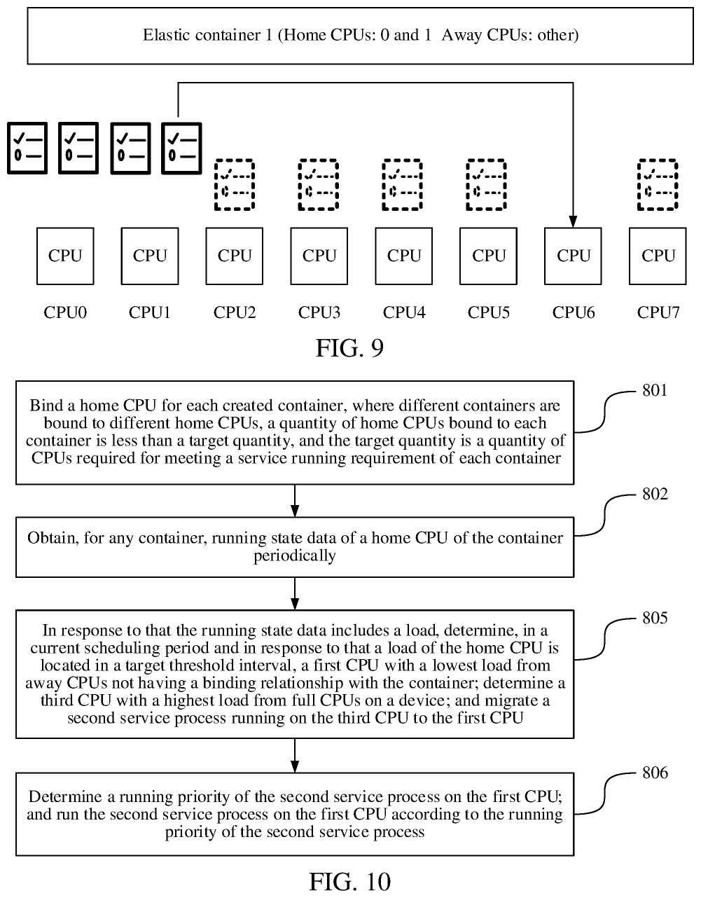

Using scaling-up logic as an example, in response to that the running state data of the home CPU meets the load balancing condition, for example, a load is increased or a scheduling delay of a service process is excessively large, some service processes need to be expanded to the away CPU for running. FIG. 9 is a schematic diagram of scaling-up logic shown according to an exemplary embodiment. In FIG. 9, a CPU1 serves as a home CPU of a container 1, and running state data thereof meets a load balancing condition, so that some service processes on the CPU1 need to be expanded to a CPU6 for running, where the CPU6 is an away CPU of the container.

In the embodiments of present disclosure, the performing service process migration between the home CPU and an away CPU on the device in response to that the running state data of the home CPU meets a load balancing condition includes but is not limited to the following several cases. Step 8031 corresponds to scaling-up logic, and step 8032 corresponds to scaling-down logic.

8031. Determine, in a current scheduling period and in response to that a load of the home CPU is higher than a first load threshold, a first CPU with a lowest load from away CPUs not having a binding relationship with the container, and migrate a first service process running on the home CPU to the first CPU; or determine, in a current scheduling period and in response to that a scheduling delay of any process in a run queue of the home CPU is greater than a first time threshold, a second CPU with a smallest scheduling delay of any process from away CPUs not having a binding relationship with the container, and migrate a first service process running on the home CPU to the second CPU.

The first CPU and the second CPU may be the same CPU or may be different CPUs, which is not limited in present disclosure. In addition, the scheduling delay of each process in the run queue of the home CPU may be targeted for a home process on the home CPU or an away process on the home CPU, which is also not limited in present disclosure.

For example, the first load threshold may be 0.8, and the first time threshold may be 24 ms, which are not limited in present disclosure. An example in which the first load threshold is 0.8 and the first time threshold is 24 ms is used, assuming that the load of the home CPU exceeds 0.8 or the scheduling delay of any process is greater than 24 ms, the dynamic scaling unit may select an idlest CPU from the away CPUs of the container, and sends an inter-processor interrupt (IPI) for mandatory load balancing to the away CPU. After receiving the IPI for mandatory load balancing, the away CPU executes mandatory load balancing until a service process is pulled from the run queue of the home CPU, and does not need to wait for a load balancing period. The load balancing period is configured for limiting an execution frequency of load balancing, to prevent load balancing from being executed frequently. Through the foregoing manner, when the load of the home CPU is excessively high or the scheduling delay of any process in the run queue is excessively large, mandatory load balancing is executed, to migrate a service process running on the home CPU to an away CPU with a lowest load or a smallest scheduling delay, thereby fully ensuring the execution timeliness of the service process on the home CPU when the home CPU is busy.

In some embodiments, the migrated first service process is a home process located at a queue tail of the run queue of the home CPU.

8032. Migrate, in the current scheduling period and when a CPU from which the first service process is migrated is the home CPU and the CPU to which the first service process is migrated is an away CPU not having a binding relationship with the container, the first service process from the CPU to which the first service process is migrated back to the home CPU in response to that the load of the home CPU is lower than a second load threshold.

Through the foregoing manner, when the load of the home CPU is relatively low, the first service process is migrated back to the home CPU, so that the first service process can still run on the home CPU at a relatively high priority, thereby fully ensuring the service performance.

804. The physical server determines, in response to migration of a first service process in the container, a running priority of the first service process on a CPU to which the first service process is migrated; and runs the first service process on the CPU to which the first service process is migrated according to the running priority of the first service process.

In the embodiments of present disclosure, when the CPU from which the first service process is migrated is the home CPU and the CPU to which the first service process is migrated is an away CPU not having a binding relationship with the container, a running priority of the first service process on the CPU to which the first service process is migrated may be set to a second running priority. That is, the first service process is run on the CPU to which the first service process is migrated at a relatively low running priority, to prevent running of a home process on the CPU from being affected.

When the CPU to which the first service process is migrated is the home CPU and the CPU from which the first service process is migrated is an away CPU not having a binding relationship with the container, the running priority of the first service process on the CPU to which the first service process is migrated may be set to a first running priority. That is, after being migrated to the home CPU, the first service process may be run at a relatively high priority.

In some other embodiments, an embodiment of present disclosure further includes another scaling-up logic. Referring to FIG. 10, the foregoing step 803 and step 804 may alternatively be replaced by the following step 805 and step 806.

805. In response to that the running state data includes a load, the physical server determines, in a current scheduling period and in response to that a load of the home CPU is located in a target threshold interval, a first CPU with a lowest load from away CPUs not having a binding relationship with the container; determines a third CPU with a highest load from full CPUs on the device; and migrates a second service process running on the third CPU to the first CPU.

In some embodiments, the migrating a second service process running on the third CPU to the first CPU includes but is not limited to the following manner: adding, after a target time length, the second service process located in a run queue of the third CPU to a run queue of the first CPU, where the target time length is set according to a load balancing period.

For example, the target threshold interval ranges from 0.6 to 0.8, which is not limited in present disclosure.

An example in which the target threshold interval ranges from 0.6 to 0.8 is used, assuming that the load of the home CPU is greater than 0.6 but less than 0.8, the dynamic scaling unit may select a most idle CPU that has a lowest load from the away CPUs of the container, and sends an IPI for periodical load balancing to the away CPU; and after receiving the IPI for periodical load balancing, the away CPU may shorten an execution period of load balancing, and for example, executes periodical load balancing when a half of the load balancing period is reached. For example, the periodical load balancing may search for a busiest CPU from the full CPUs, to further pull a service process from the busiest CPU. Through the foregoing manner, by using a periodical load balancing policy, a service process is pulled from the busiest CPU in the full CPUs and migrated to the idlest CPU, thereby improving the resource utilization and improving the load balancing performance between CPUs on the entire system.

In some other embodiments, the migrated second service process is a home process located at a queue tail of the run queue of the CPU.

806. The physical server determines a running priority of the second service process on the first CPU; and runs the second service process on the first CPU according to the running priority of the second service process.

This step is similar to the foregoing step 804, and details are not described herein again.

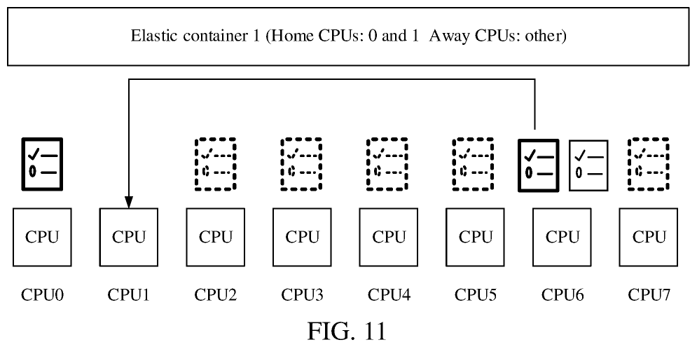

In some other embodiments, an embodiment of present disclosure further includes scaling-down logic. For the scaling-down logic, for example, when a service process on the home CPU is run on an away CPU, in response to that running state data of the away CPU meets a load balancing condition, for example, when a load is increased or a scheduling delay of the migrated service process is excessively large, a scaling-down operation may be triggered. FIG. 11 is a schematic diagram of scaling-down logic shown according to an exemplary embodiment. In FIG. 11, a CPU6 serves as an away CPU of a container 1, and running state data thereof meets a load balancing condition, so that a load is increased because the CPU6 runs a home process, and a migrated service process needs to be migrated back to a home CPU, namely, a CPU1 for running.

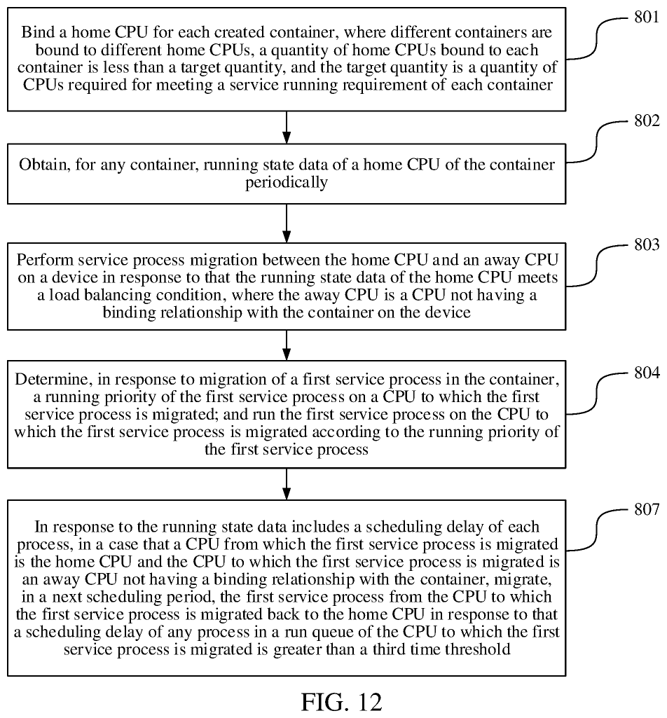

Referring to FIG. 12, the following step 807 is further included after step 804.

807. In response to that the running state data includes a scheduling delay of each process, when a CPU from which the first service process is migrated is the home CPU and the CPU to which the first service process is migrated is an away CPU not having a binding relationship with the container, the physical server migrates, in a next scheduling period, the first service process from the CPU to which the first service process is migrated back to the home CPU in response to that a scheduling delay of any process in a run queue of the CPU to which the first service process is migrated is greater than a third time threshold.

For example, the third time threshold may be 24 ms, which is not limited in present disclosure.

An example in which the third time threshold is 24 ms is used, assuming that a scheduling delay of the first service process on the away CPU is greater than 24 ms, the dynamic scaling unit may send an IPI for mandatory load balancing to the home CPU; and after receiving the IPI for mandatory load balancing, the home CPU executes mandatory load balancing until the first service process is pulled from a run queue of the away CPU, and the first service process may be run at a relatively high priority after being migrated back to the home CPU. Through the foregoing manner, when a scheduling delay of any process in the run queue of the away CPU is relatively large, the first service process is migrated back to the home CPU, to ensure that the first service process can be run in time.

In some other embodiments, an embodiment of present disclosure further includes another scaling-down logic.

When the CPU from which the first service process is migrated is the home CPU and the CPU to which the first service process is migrated is an away CPU not having a binding relationship with the container, the scaling-down logic shown in the embodiments of present disclosure further includes:
determining, in a next scheduling period, the third CPU with a highest load from the full CPUs on the device in response to that a load of the CPU to which the first service process is migrated is higher than a third load threshold; migrating a third service process running on the third CPU to the home CPU; determining a running priority of the third service process on the home CPU; and running the third service process on the home CPU according to the running priority of the third service process; or
determining, in a next scheduling period, a fourth CPU with a largest scheduling delay of any process from the full CPUs on the device in response to that a scheduling delay of any process in a run queue of the CPU to which the first service process is migrated is greater than a second time threshold; migrating a fourth service process running on the fourth CPU to the home CPU; determining a running priority of the fourth service process on the home CPU; and running the fourth service process on the home CPU according to the running priority of the fourth service process.

In some other embodiments, the third CPU and the fourth CPU may be the same CPU or may be different CPUs, and correspondingly, the third service process and the fourth service process may be the same service process or may be different service processes, which are not limited in present disclosure. In addition, the migrated third service process and fourth service process each may be a home process located at a queue tail of a run queue of a corresponding CPU, which is also not limited in present disclosure.

For example, the third load threshold may be 0.7, and the second time threshold may be 18 ms, which are not limited in present disclosure. An example in which the third load threshold is 0.7 and the second time threshold is 18 ms is used, assuming that a load of the away CPU exceeds 0.7 or a scheduling delay of any process is greater than 18 ms, the dynamic scaling unit may send an IPI for periodical load balancing to the home CPU; and after receiving the IPI for periodical load balancing, the home CPU may ignore time control over the load balancing period and directly performs periodical load balancing, to search for a most busy CPU from full CPUs until a service process is pulled from a run queue of the CPU. Through the foregoing manner, when the away CPU is too busy, periodical load balancing is executed to migrate a service process on the busy CPU to a CPU that is relatively idle, thereby fully ensuring load balancing of the full CPUs.

When the scheduling solution provided in the embodiments of present disclosure is applied to a scenario that different services are deployed on the same device, the scheduling solution first provides concepts of a home CPU and an away CPU based on a binding relationship between a container on a device and CPUs; and for any container, a CPU having a binding relationship with the container is referred to as a home CPU of the container, and a CPU not having a binding relationship with the container is referred to as an away CPU of the container. In addition, a quantity of CPUs bound to each container is less than a target quantity, where the target quantity is a quantity of CPUs required for meeting a service running requirement of the container. Each container is bound to a small quantity of CPUs, so that more containers can be deployed on the same device for use by different services, so that relatively high CPU resource overcommitting is implemented, and the resource utilization can be improved. The overcommitting herein refers to that actually owned CPU resources are less than allocated CPU resources.

In addition, the embodiments of present disclosure further support service process scheduling between a plurality of CPUs, which can implement service process migration efficiently. This scheduling manner can avoid occurrence of a case that even if some CPUs are in an idle state, these CPUs cannot be used to run a service process, thereby ensuring the resource utilization.

In addition, the embodiments of present disclosure further provides a concept of a running priority; and for example, assuming that a first service process in the container is migrated, a running priority of the first service process on a CPU to which the first service process is migrated is determined, and the first service process is further run on the CPU to which the first service process is migrated according to the running priority of the first service process. This priority-based control manner can avoid occurrence of a case that different services conflict with each other. Running of the first service process on the CPU to which the first service process is migrated according to the determined priority does not affect running of each service process in each container bound to the CPU on the CPU, thereby ensuring the service performance.

In conclusion, the scheduling solution provided in the embodiments of present disclosure can consider the service performance and the resource utilization. For example, for a container cloud scenario, the embodiments of present disclosure provide a new manner for allocating CPU resources for each container, thereby considering the container performance and a CPU overcommit ratio. In addition, a service process has different priorities when run on a home CPU and an away CPU, thereby ensuring the service performance.

In some other embodiments, for the foregoing step 804, if the CPU to which the first service process is migrated does not run a home process of the CPU, an away process running on the CPU may be temporarily set to a high priority according to a specific rule and then switched to a low priority when the home process is run. In detail, when the CPU to which the first service process is migrated is an away CPU not having a binding relationship with the container, the method provided in the embodiments of present disclosure further includes: adjusting the running priority of the first service process to the second running priority temporarily in response to that a home process of the CPU to which the first service process is migrated is not run currently and a service to which the first service process in away processes currently running on the CPU to which the first service process is migrated belongs has highest delay sensitivity; and adjusting the running priority of the first service process back to the first running priority in response to that the home process of the CPU to which the first service process is migrated is in a ready state. The delay sensitivity is configured for representing a sensitivity degree of a service to a delay. For example, the delay sensitivity of a game service is relatively high. Through the foregoing manner, when the CPU to which the first service process is migrated does not run the home process of the CPU, an away process on the CPU may be temporarily set to a high priority and then switched to a low priority when the home process is run, thereby fully utilizing processing resources of the CPU and improving the execution efficiency of the service process as much as possible.

In some other embodiments, the performing service process migration between the home CPU and an away CPU in response to that the running state data of the home CPU meets a load balancing condition may further include: determining, in the current scheduling period and in response to that the running state data of the home CPU meets the load balancing condition and the CPU from which the first service process is migrated is the home CPU, a plurality of candidate objects to which the first service process is migrated from the away CPUs not having a binding relationship with the container according to running state data in the current scheduling period; predicting running state data of the plurality of candidate objects to which the first service process is migrated in a plurality of subsequent scheduling periods; determining the CPU to which the first service process is migrated from the plurality of candidate objects to which the first service process is migrated according to the running state data in the current scheduling period and the predicted running state data of the plurality of candidate objects to which the first service process is migrated; and performing service process migration between the home CPU and the CPU to which the first service process is migrated. For example, prediction may be performed according to a quantity of processes in a run queue of each candidate object to which the first service process is migrated, or prediction may be performed according to a service type processed by a container bound to each candidate object to which the first service process is migrated, which is not limited in present disclosure. Through the foregoing manner, a plurality of CPUs are used as candidate objects to which the first service process is migrated, running state data of the candidate objects to which the first service object is migrated in the subsequent several scheduling periods is then predicted, and load balancing is completed based on the running state data, so that a load balancing operation can be prevented from being performed frequently, thereby reducing processing overheads.

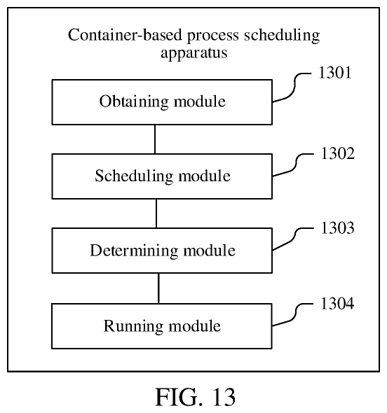

FIG. 13 is a schematic structural diagram of a container-based process scheduling apparatus shown according to an exemplary embodiment. Referring to FIG. 13, the apparatus includes the following modules:
an obtaining module 1301, configured to obtain, for any container, running state data of a home CPU of the container periodically, where the home CPU is a CPU having a binding relationship with the container on a device, a quantity of CPUs bound to the container is less than a target quantity, and the target quantity is a quantity of CPUs required for meeting a service running requirement of the container;
a scheduling module 1302, configured to perform service process migration between the home CPU and an away CPU in response to that the running state data of the home CPU meets a load balancing condition, where the away CPU is a CPU not having a binding relationship with the container on the device;
a determining module 1303, configured to determine, in response to migration of a first service process in the container, a running priority of the first service process on a CPU to which the first service process is migrated; and
a running module 1304, configured to run the first service process on the CPU to which the first service process is migrated according to the running priority of the first service process.

According to the scheduling solution provided in the embodiments of present disclosure, concepts of a home CPU and an away CPU are first provided based on a binding relationship between a container on a device and CPUs; and for any container, a CPU having a binding relationship with the container is referred to as a home CPU of the container, and a CPU not having a binding relationship with the container is referred to as an away CPU of the container. In addition, a quantity of CPUs bound to each container is less than a target quantity, where the target quantity is a quantity of CPUs required for meeting a service running requirement of the container. Each container is bound to a small quantity of CPUs, so that more containers can be deployed on the same device for use by different services, relatively high CPU resource overcommitting is implemented, and the resource utilization can be improved. The overcommitting herein refers to that actually owned CPU resources are less than allocated CPU resources.

In addition, the embodiments of present disclosure further support service process scheduling between a plurality of CPUs. In detail, for any home CPU of the container, in response to that running state data of the home CPU meets a load balancing condition, service process migration is performed between the home CPU and an away CPU of the container. This scheduling manner can avoid occurrence of a case that even if some CPUs are in an idle state, these CPUs cannot be used to run a service process, thereby ensuring the resource utilization.

In addition, the embodiments of present disclosure further provides a concept of a running priority; and assuming that a first service process in the container is migrated, a running priority of the first service process on a CPU to which the first service process is migrated is determined, and the first service process is further run on the CPU to which the first service process is migrated according to the running priority of the first service process. This priority-based control manner can avoid occurrence of a case that different services conflict with each other. Running of the first service process on the CPU to which the first service process is migrated according to the determined priority does not affect running of each service process in each container bound to the CPU on the CPU, thereby ensuring the service performance.

In conclusion, the scheduling solution provided in the embodiments of present disclosure can consider the service performance and the resource utilization.

In some embodiments, the running state data includes a scheduling delay of each process in a run queue of the home CPU; and the obtaining module is configured to obtain a scheduling delay of each home process in a home process list of the home CPU periodically, where the home process is a service process in the container; and obtain a scheduling delay of each away process in an away process list of the home CPU periodically, where the away process is a service process in a container not having a binding relationship with the home CPU.

In some embodiments, the determining module is configured to set, in response to that the CPU to which the first service process is migrated is the home CPU, the running priority of the first service process on the CPU to which the first service process is migrated to a first running priority; and set, in response to that the CPU to which the first service process is migrated is an away CPU not having a binding relationship with the container, the running priority of the first service process on the CPU to which the first service process is migrated to a second running priority, where the first running priority is higher than the second running priority.

In some embodiments, the running state data includes a load of the home CPU; and the scheduling module is configured to determine, in a current scheduling period and in response to that the load of the home CPU is higher than a first load threshold, a first CPU with a lowest load from away CPUs not having a binding relationship with the container; and migrate the first service process running on the home CPU to the first CPU.

In some embodiments, the running state data includes the scheduling delay of each process in the run queue of the home CPU; and the scheduling module is configured to determine, in a current scheduling period and in response to that the scheduling delay of any process in the run queue of the home CPU is greater than a first time threshold, a second CPU with a smallest scheduling delay of any process from away CPUs not having a binding relationship with the container; and migrate the first service process running on the home CPU to the second CPU.

In some embodiments, the running state data includes the load of the home CPU; and the scheduling module is configured to migrate, in the current scheduling period and when a CPU from which the first service process is migrated is the home CPU and the CPU to which the first service process is migrated is an away CPU not having a binding relationship with the container, the first service process from the CPU to which the first service process is migrated back to the home CPU in response to that the load of the home CPU is lower than a second load threshold.

In some embodiments, the running state data includes the load of the home CPU; the scheduling module is further configured to determine, in the current scheduling period and in response to that the load of the home CPU is located in a target threshold interval, the first CPU with a lowest load from the away CPUs not having a binding relationship with the container; determine a third CPU with a highest load from full CPUs on the device; and migrate a second service process running on the third CPU to the first CPU;
the determining module is further configured to determine a running priority of the second service process on the first CPU; and
the running module is further configured to run the second service process on the first CPU according to the running priority of the second service process.

In some embodiments, the running module is configured to add, after a target time length, the second service process located in a run queue of the third CPU to a run queue of the first CPU, where the target time length is set according to a load balancing period.

In some embodiments, the running state data includes the load of the home CPU; when a CPU from which the first service process is migrated is the home CPU and the CPU to which the first service process is an away CPU not having a binding relationship with the container, the scheduling module is further configured to determine, in a next scheduling period, the third CPU with a highest load from the full CPUs on the device in response to that a load of the CPU to which the first service process is migrated is higher than a third load threshold; and migrate a third service process running on the third CPU to the home CPU;
the determining module is further configured to determine a running priority of the third service process on the home CPU; and
the running module is further configured to run the third service process on the home CPU according to the running priority of the third service process.

In some embodiments, the running state data includes the scheduling delay of each process in the run queue of the home CPU; and when a CPU from which the first service process is migrated is the home CPU and the CPU to which the first service process is an away CPU not having a binding relationship with the container, the scheduling module is further configured to determine, in a next scheduling period, a fourth CPU with a largest scheduling delay of any process from the full CPUs on the device in response to that a scheduling delay of any process in a run queue of the CPU to which the first service process is migrated is greater than a second time threshold; and migrate a fourth service process running on the fourth CPU to the home CPU;
the determining module is further configured to determine a running priority of the fourth service process on the home CPU; and
the running module is further configured to run the fourth service process on the home CPU according to the running priority of the fourth service process.

In some embodiments, the running state data includes the scheduling delay of each process in the run queue of the home CPU; and when a CPU from which the first service process is migrated is the home CPU and the CPU to which the first service process is an away CPU not having a binding relationship with the container, the scheduling module is further configured to migrate, in a next scheduling period, the first service process from the CPU to which the first service process is migrated back to the home CPU in response to that a scheduling delay of any process in a run queue of the CPU to which the first service process is migrated is greater than a third time threshold.

In some embodiments, when the CPU to which the first service process is migrated is an away CPU not having a binding relationship with the container, the determining module is further configured to adjust the running priority of the first service process to the second running priority temporarily in response to that a home process of the CPU to which the first service process is migrated is not run currently and a service to which the first service process in away processes currently running on the CPU to which the first service process is migrated belongs has highest delay sensitivity; and adjust the running priority of the first service process back to the first running priority in response to that the home process of the CPU to which the first service process is migrated is in a ready state.

In some embodiments, the scheduling module is further configured to determine, in the current scheduling period and in response to that the running state data of the home CPU meets the load balancing condition and the CPU from which the first service process is migrated is the home CPU, a plurality of candidate objects to which the first service process is migrated from the away CPUs not having a binding relationship with the container according to running state data in the current scheduling period; predict running state data of the plurality of candidate objects to which the first service process is migrated in a plurality of subsequent scheduling periods; determine the CPU to which the first service process is migrated from the plurality of candidate objects to which the first service process is migrated according to the running state data in the current scheduling period and the predicted running state data of the plurality of candidate objects to which the first service process is migrated; and perform service process migration between the home CPU and the CPU to which the first service process is migrated.

According to the scheduling solution provided in the embodiments of present disclosure, concepts of a home CPU and an away CPU are first provided based on a binding relationship between a container on a device and CPUs; and for any container, a CPU having a binding relationship with the container is referred to as a home CPU of the container, and a CPU not having a binding relationship with the container is referred to as an away CPU of the container. In addition, a quantity of CPUs bound to each container is less than a target quantity, where the target quantity is a quantity of CPUs required for meeting a service running requirement of each container. Each container is bound to a small quantity of CPUs, so that more containers can be deployed on the same device for use by different services, relatively high CPU resource overcommitting is implemented, and the resource utilization can be improved. The overcommitting herein refers to that actually owned CPU resources are less than allocated CPU resources.

In addition, the embodiments of present disclosure further support service process scheduling between a plurality of CPUs. In detail, for any home CPU of the container, in response to that running state data of the home CPU meets a load balancing condition, service process migration is performed between the home CPU and an away CPU of the container. This scheduling manner can avoid occurrence of a case that even if some CPUs are in an idle state, these CPUs cannot be used to run a service process, thereby ensuring the resource utilization.

In addition, the embodiments of present disclosure further provides a concept of a running priority; and assuming that a first service process in the container is migrated, a running priority of the first service process on a CPU to which the first service process is migrated is determined, and the first service process is further run on the CPU to which the first service process is migrated according to the running priority of the first service process. This priority-based control manner can avoid occurrence of a case that different services conflict with each other. Running of the first service process on the CPU to which the first service process is migrated according to the determined priority does not affect running of each service process in each container bound to the CPU on the CPU, thereby ensuring the service performance.

The scheduling solution provided in the embodiments of present disclosure can consider the service performance and the resource utilization.

Any combination of the foregoing optional technical solutions may be used to form an optional embodiment of the present disclosure. Details are not described herein.

When the container-based process scheduling apparatus provided in the foregoing embodiments performs process scheduling, only divisions of the foregoing functional modules are described by using an example. During actual application, the foregoing functions may be allocated to and completed by different functional modules according to requirements, that is, an internal structure of the apparatus is divided into different functional modules, to complete all or some of the foregoing described functions. In addition, the container-based process scheduling apparatus provided in the foregoing embodiments and the embodiments of the container-based process scheduling method belong to the same concept. For details of a specific implementation process, reference may be made to the method embodiments. Details are not described herein again.

In an exemplary embodiment, a computer-readable storage medium, for example, a memory including a computer program, is further provided. The computer program may be executed by a processor of a computer device to complete the container-based process scheduling method in the foregoing embodiments. For example, the computer-readable storage medium may be a read-only memory (ROM), a random access memory (RAM), a compact disc read-only memory (CD-ROM), a magnetic tape, a floppy disk, an optical data storage device, or the like.

In an exemplary embodiment, a computer program product is provided, including a computer program, where the computer program is stored in a computer-readable storage medium, a processor of a computer device reads the computer program from the computer-readable storage medium and executes the computer program, to cause the computer device to perform the container-based process scheduling method described above.

A person of ordinary skill in the art may understand that all or a part of the steps of the embodiments may be implemented by hardware or a program instructing relevant hardware. The program may be stored in a computer-readable storage medium. The storage medium may be a read-only memory, a magnetic disk, or an optical disc.

The foregoing merely describes optional embodiments of present disclosure, but are not intended to limit present disclosure. Any modification, equivalent replacement, or improvement made within the spirit and principle of present disclosure shall fall within the protection scope of present disclosure.

What is claimed is:

1. A container-based process scheduling method, performed by a computer device, the method comprising:
obtaining, for a container, running state data of a home central processing unit (CPU) of the container periodically, the home CPU being a CPU having a binding relationship with the container on a device, a quantity of CPUs bound to the container being less than a target quantity, and the target quantity being a quantity of CPUs required for meeting a service running requirement of the container;
performing service process migration between the home CPU and an away CPU in response to the running state data of the home CPU meeting a load balancing condition, the away CPU being a CPU not having a binding relationship with the container on the device; and
determining, in response to a first service process in the container being migrated, a running priority of the first service process on a CPU to which the first service process is migrated; and running the first service process on the CPU to which the first service process is migrated according to the running priority of the first service process.

2. The method according to claim 1, wherein the running state data comprises a scheduling delay of each process in a run queue of the home CPU; and
obtaining the running state data of the home CPU of the container periodically comprises:
obtaining a scheduling delay of a home process in a home process list of the home CPU periodically, wherein the home process is a service process in the container; and
obtaining a scheduling delay of an away process in an away process list of the home CPU periodically, wherein the away process is a service process in a container not having a binding relationship with the home CPU.

3. The method according to claim 2, wherein determining the running priority of the first service process on the CPU to which the first service process is migrated comprises:
setting, in response to that the CPU to which the first service process is migrated is the home CPU, the running priority of the first service process on the CPU to which the first service process is migrated to a first running priority; and
setting, in response to that the CPU to which the first service process is migrated is an away CPU not having a binding relationship with the container, the running priority of the first service process on the CPU to which the first service process is migrated to a second running priority, wherein
the first running priority is higher than the second running priority.

4. The method according to claim 1, wherein the running state data comprises a load of the home CPU and the scheduling delay of each process in the run queue of the home CPU; and
performing the service process migration between the home CPU and the away CPU in response to the running state data of the home CPU meeting the load balancing condition comprises:
determining, in a current scheduling period and in response to that the load of the home CPU is higher than a first load threshold, a first CPU with a lowest load from away CPUs not having a binding relationship with the container; and migrating the first service process running on the home CPU to the first CPU; or
determining, in a current scheduling period and in response to that the scheduling delay of any process in the run queue of the home CPU is greater than a first time threshold, a second CPU with a smallest scheduling delay of any process from away CPUs not having a binding relationship with the container; and migrating the first service process running on the home CPU to the second CPU.

5. The method according to claim 1, wherein the running state data comprises the load of the home CPU; and
performing the service process migration between the home CPU and the away CPU in response to the running state data of the home CPU meeting the load balancing condition comprises:
migrating, in the current scheduling period and when a CPU from which the first service process is migrated is the home CPU and the CPU to which the first service process is migrated is an away CPU not having a binding relationship with the container, the first service process from the CPU to which the first service process is migrated back to the home CPU in response to that the load of the home CPU is lower than a second load threshold.

6. The method according to claim 1, wherein the running state data comprises the load of the home CPU; and the method further comprises:
determining, in the current scheduling period and in response to that the load of the home CPU is located in a target threshold interval, the first CPU with a lowest load from the away CPUs not having a binding relationship with the container;
determining a third CPU with a highest load from full CPUs on the device;
migrating a second service process running on the third CPU to the first CPU;
determining a running priority of the second service process on the first CPU; and
running the second service process on the first CPU according to the running priority of the second service process.

7. The method according to claim 6, wherein migrating the second service process running on the third CPU to the first CPU comprises:
adding, after a target time length, the second service process located in a run queue of the third CPU to a run queue of the first CPU, wherein
the target time length is set according to a load balancing period.

8. The method according to claim 1, wherein the running state data comprises the load of the home CPU and the scheduling delay of each process in the run queue of the home CPU; and
when the CPU from which the first service process is migrated is the home CPU and the CPU to which the first service process is migrated is an away CPU not having a binding relationship with the container, the method further comprises:
determining, in a next scheduling period, the third CPU with a highest load from the full CPUs on the device in response to that a load of the CPU to which the first service process is migrated is higher than a third load threshold; migrating a third service process running on the third CPU to the home CPU; determining a running priority of the third service process on the home CPU; and running the third service process on the home CPU according to the running priority of the third service process; or
determining, in a next scheduling period, a fourth CPU with a largest scheduling delay of any process from the full CPUs on the device in response to that a scheduling delay of any process in a run queue of the CPU to which the first service process is migrated is greater than a second time threshold; migrating a fourth service process running on the fourth CPU to the home CPU; determining a running priority of the fourth service process on the home CPU; and running the fourth service process on the home CPU according to the running priority of the fourth service process.

9. The method according to claim 1, wherein the running state data comprises the scheduling delay of each process in the run queue of the home CPU; and
when the CPU from which the first service process is migrated is the home CPU and the CPU to which the first service process is migrated is an away CPU not having a binding relationship with the container, the method further comprises:
migrating, in the next scheduling period, the first service process from the CPU to which the first service process is migrated back to the home CPU in response to that the scheduling delay of any process in the run queue of the CPU to which the first service process is migrated is greater than a third time threshold.

10. The method according to claim 3, wherein when the CPU to which the first service process is migrated is the away CPU not having the binding relationship with the container, the method further comprises:
adjusting the running priority of the first service process to the second running priority temporarily in response to that a home process of the CPU to which the first service process is migrated is not run currently and a service to which the first service process in away processes currently running on the CPU to which the first service process is migrated belongs has highest delay sensitivity; and
adjusting the running priority of the first service process back to the first running priority in response to that the home process of the CPU to which the first service process is migrated is in a ready state.

11. The method according to claim 1, wherein performing the service process migration between the home CPU and the away CPU in response to the running state data of the home CPU meeting the load balancing condition comprises:
determining, in the current scheduling period and in response to that the running state data of the home CPU meets the load balancing condition and the CPU from which the first service process is migrated is the home CPU, a plurality of candidate objects to which the first service process is migrated from the away CPUs not having a binding relationship with the container according to running state data in the current scheduling period;
predicting running state data of the plurality of candidate objects to which the first service process is migrated in a plurality of subsequent scheduling periods;
determining the CPU to which the first service process is migrated from the plurality of candidate objects to which the first service process is migrated according to the running state data in the current scheduling period and the predicted running state data of the plurality of candidate objects to which the first service process is migrated; and
performing service process migration between the home CPU and the CPU to which the first service process is migrated.

12. A computer device, comprising one or more processors and a memory containing a computer program that when being loaded and executed, causes the one or more processors to perform:
obtaining, for a container, running state data of a home central processing unit (CPU) of the container periodically, the home CPU being a CPU having a binding relationship with the container on a device, a quantity of CPUs bound to the container being less than a target quantity, and the target quantity being a quantity of CPUs required for meeting a service running requirement of the container;
performing service process migration between the home CPU and an away CPU in response to the running state data of the home CPU meeting a load balancing condition, the away CPU being a CPU not having a binding relationship with the container on the device; and
determining, in response to a first service process in the container being migrated, a running priority of the first service process on a CPU to which the first service process is migrated; and running the first service process on the CPU to which the first service process is migrated according to the running priority of the first service process.

13. The device according to claim 12, wherein the running state data comprises the scheduling delay of each process in the run queue of the home CPU; and
when the CPU from which the first service process is migrated is the home CPU and the CPU to which the first service process is migrated is an away CPU not having a binding relationship with the container, the one or more processors are further configured to perform:
migrating, in the next scheduling period, the first service process from the CPU to which the first service process is migrated back to the home CPU in response to that the scheduling delay of any process in the run queue of the CPU to which the first service process is migrated is greater than a third time threshold.

14. The device according to claim 12, wherein the running state data comprises a scheduling delay of each process in a run queue of the home CPU; and
the one or more processors are further configured to perform:
obtaining a scheduling delay of a home process in a home process list of the home CPU periodically, wherein the home process is a service process in the container; and
obtaining a scheduling delay of an away process in an away process list of the home CPU periodically, wherein the away process is a service process in a container not having a binding relationship with the home CPU.

15. The device according to claim 13, wherein the one or more processors are further configured to perform:
setting, in response to that the CPU to which the first service process is migrated is the home CPU, the running priority of the first service process on the CPU to which the first service process is migrated to a first running priority; and
setting, in response to that the CPU to which the first service process is migrated is an away CPU not having a binding relationship with the container, the running priority of the first service process on the CPU to which the first service process is migrated to a second running priority, wherein
the first running priority is higher than the second running priority.

16. The device according to claim 12, wherein the running state data comprises a load of the home CPU and the scheduling delay of each process in the run queue of the home CPU; and
the one or more processors are further configured to perform:
determining, in a current scheduling period and in response to that the load of the home CPU is higher than a first load threshold, a first CPU with a lowest load from away CPUs not having a binding relationship with the container; and migrating the first service process running on the home CPU to the first CPU; or
determining, in a current scheduling period and in response to that the scheduling delay of any process in the run queue of the home CPU is greater than a first time threshold, a second CPU with a smallest scheduling delay of any process from away CPUs not having a binding relationship with the container; and migrating the first service process running on the home CPU to the second CPU.

17. The device according to claim 12, wherein the running state data comprises the load of the home CPU; and
the one or more processors are further configured to perform:
migrating, in the current scheduling period and when a CPU from which the first service process is migrated is the home CPU and the CPU to which the first service process is migrated is an away CPU not having a binding relationship with the container, the first service process from the CPU to which the first service process is migrated back to the home CPU in response to that the load of the home CPU is lower than a second load threshold.

18. The device according to claim 12, wherein the running state data comprises the load of the home CPU; and the one or more processors are further configured to perform:
determining, in the current scheduling period and in response to that the load of the home CPU is located in a target threshold interval, the first CPU with a lowest load from the away CPUs not having a binding relationship with the container;
determining a third CPU with a highest load from full CPUs on the device;
migrating a second service process running on the third CPU to the first CPU;
determining a running priority of the second service process on the first CPU; and
running the second service process on the first CPU according to the running priority of the second service process.

19. The device according to claim 18, wherein the one or more processors are further configured to perform:
adding, after a target time length, the second service process located in a run queue of the third CPU to a run queue of the first CPU, wherein
the target time length is set according to a load balancing period.

20. A non-transitory computer-readable storage medium containing a computer program that, when being loaded and executed, causes one or more processors to perform:
obtaining, for a container, running state data of a home central processing unit (CPU) of the container periodically, the home CPU being a CPU having a binding relationship with the container on a device, a quantity of CPUs bound to the container being less than a target quantity, and the target quantity being a quantity of CPUs required for meeting a service running requirement of the container;
performing service process migration between the home CPU and an away CPU in response to the running state data of the home CPU meeting a load balancing condition, the away CPU being a CPU not having a binding relationship with the container on the device; and
determining, in response to a first service process in the container being migrated, a running priority of the first service process on a CPU to which the first service process is migrated; and running the first service process on the CPU to which the first service process is migrated according to the running priority of the first service process.
